(19) United States
(12) Patent Application Publication
(10) Pub. No.: US 2012/0296718 A1
(43) Pub. Date: Nov. 22, 2012

(54) REFERRAL INCENTIVIZED ONLINE TRANSACTIONS

(76) Inventors: Renee Kennedy, Webster, TX (US); Joanne Denise Pruitt, Friendswood, TX (US)

(21) Appl. No.: 13/474,211

(22) Filed: May 17, 2012

Related U.S. Application Data
(60) Provisional application No. 61/487,652, filed on May 18, 2011.

(51) Int. Cl. G06Q 30/02; G06Q 30/06; G06F 15/16

(52) U.S. Cl. 705/14.16

(57) ABSTRACT

Disclosed herein is a method for conducting electronic commerce comprising generating a first specific link uniquely associating the first member user identifier with an item; receiving a request for the first item via a click-through of the first specific link that results in a financial transaction on the electronic commerce website associated with the first item; and determining an amount of a commission receivable by the first member associated with the financial transaction associated with the first item. A system for conducting electronic commerce is also disclosed.

### CROSS REFERENCE TO RELATED APPLICATIONS

This application claims priority to and the benefit of provisional application U.S. 61/487,652, filed May 18, 2011, which is hereby incorporated herein by reference in its entire

### BACKGROUND

Embodiments of the inventive subject matter generally relate to the field of online transactions and more particularly to online transactions incentivized by referrals.

In recent years, online marketplaces have become well known, and consumers routinely search for and purchase products and services from online merchants in one or more online marketplaces. Some online marketplaces, such as www.amazon.com, www.ebay.com and www.facebook.com, can serve to facilitate sales of online merchants by providing the virtual infrastructure for online transactions between consumers and merchants. These facilitators typically charge a fee or commission for providing the virtual infrastructure for online merchants and consumers.

In online marketplaces, consumers view products and services and make a decision whether to purchase the products or services. Purchasing online from the convenience of any location is one a reason why online purchases have been increasing, and are expected to increase, in number. With increasing numbers of consumers with the ability and will to do online transactions, online merchants and marketplaces need ways to attract consumers to their products and services. Moreover, with the number of online merchants increasing because of an increasing number of online consumers, online merchants and marketplaces need to incentivize using a particular online merchant or marketplace over another.

### SUMMARY

Embodiments of the invention include a method, a machine readable medium, and a system. An embodiment of a method includes accessing an online marketplace, creating a profile, attempting to list an item, obtaining/generating a link, communicating the link to other current and potential users of the methods, clicking-through the link by a consumer, recording information regarding the click-throughs, determining if a transaction has occurred, determining if a marketer is identified with the transaction, determining a commission for the marketer, and awarding the commission. An embodiment of a system may have a first consumer device, a second consumer device, a referral server, and a marketplace server all connected through a network. The referral server and the marketplace server may be connected outside of the network. Embodiments of the systems and methods may be captured in a machine-readable medium.

### BRIEF DESCRIPTION OF THE DRAWINGS

The present embodiments may be better understood, and numerous objects, features, and advantages made apparent to those skilled in the art by referencing the accompanying drawings.

FIG. 1 depicts a block diagram of a networked system configured to manage online transactions and referrals in accordance with an embodiment of the invention.

FIG. 2 depicts a flowchart showing a method performed by the system in FIG. 1 according to one embodiment.

FIG. 3 depicts a flowchart showing a method for listing an item according to one inventive embodiment.

FIG. 4 depicts a flowchart showing a method for determining marketer commission according to one inventive embodiment.

FIG. 5 depicts a block diagram of a computer system suitable for implementing one or more embodiments of the present disclosure.

### DESCRIPTION

The description that follows includes exemplary devices, methods, memory, systems, techniques, instruction sequences and computer program products that embody techniques of the present inventive subject matter. However, it should be understood that the described embodiments may be practiced without these specific details. Well-known instruction instances, protocols, structures and techniques have not been shown in detail in order not to obfuscate the description.

The present embodiments may be better understood, and numerous objects, features, and advantages made apparent to those skilled in the art by referencing the accompanying drawings. At the outset, it should be noted that in the development of any such actual embodiment, numerous implementation-specific decisions must be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In addition, the composition used/disclosed herein can also comprise some components other than those cited.

The inventive subject matter includes devices, methods, machine-readable mediums, and systems utilizing referrals in an online transactions environment. The environment can be used in conjunction with mobile devices, such as but not limited to mobile phones, tablet PCs, laptops, and other Internet-accessible devices. The inventive subject matter allows online merchants and marketplaces to incentivize referrals to their online websites, thus increasing traffic to items available for transactions and, in turn, increasing the chance of entering transactions with consumers of the items. Additionally, the inventive subject matter provides for an interactive way for consumers and potential consumers to affirmatively click to a merchant or marketplace's item without a solicitation directly from the merchant or marketplace or payment provider.

Embodiments of the methods are shown in the figures and discussed below, and it should be understood the operations as presented are exemplary and some operations may be substituted, added, rearranged or removed while still encompassing the inventive subject matter. Moreover, it should be understood the order of operations is not to be limited unless explicitly specified herein.

As will be appreciated by one skilled in the art, aspects of the present inventive subject matter may be embodied as a system, method or computer program product. Accordingly, aspects of the present inventive subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present inventive subject matter may take the form of a computer program product embodied in one or more machine readable medium(s) having machine readable program code embodied thereon.

Any combination of one or more machine readable medium(s) may be utilized. The machine readable medium may be a machine readable signal medium or a machine readable storage medium. A machine readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the machine readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wired, optical fiber cable, RF, etc., or any suitable combination of the foregoing.

Computer program code for carrying out operations for aspects of the present inventive subject matter may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present inventive subject matter are described with reference to flowchart illustrations and/or block diagrams of methods, apparatus (systems) and computer program products according to embodiments of the inventive subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

For purposes herein, electronic commerce refers to internet commerce, WWW commerce, cellphone network commerce, mobile communication, private network commerce, and/or any other form of commerce involving electronic communication.

A click through is defined as the process of a user clicking on a link, e.g., a URL, and being directed to another web site offering information or an offer for sale of the item associated with the link.

These computer program instructions may also be stored in a machine readable medium that can direct a computer, other programmable data processing apparatus, or other devices to function in a particular manner, such that the instructions stored in the machine readable medium produce an article of manufacture including instructions which implement the functional act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

“Transaction(s)” as used herein may refer to any type of transaction with a merchant, such as a purchase, a rental, a license, a lease, rent-to-own, a barter, and the like.

“Commission(s)” as used herein may refer to any type of award such as a cash value, a discount on a transaction, a credit, and the like.

“Communicate” as used herein may refer to posting on a message board or forum or a social network, emailing, texting, and the like.

“Product(s) and service(s)” as used herein may include, without limitation:

Advertisement and publicity services by television, radio, mail; Advertisement for others on the Internet; Advertising and commercial information services, via the internet; Advertising and marketing; Advertising and marketing services, namely, promoting the goods and services of others; Advertising and promotional services; Advertising and publicity services, namely, promoting the goods, services, brand identity and commercial information and news of third parties through print, audio, video, digital and online medium; Development, operation and administration of digital signage systems and digital advertising systems for others, namely, providing advertising space by electronic means and global computer information networks; Dissemination of advertising for others via the Internet; Internet advertising services; Online retail store services featuring software, movies, music, DVDs, apparel, toys, games, ring tones, books; Post-production editing services for video and audio commercials; Promoting the goods and services of others by means of distributing advertising on the Internet; Providing business information, also via internet, the cable network or other forms of data transfer; Audio and video broadcasting services over the Internet; Broadcasting of video and audio programming over the Internet; Broadcasting services and provision of telecommunication access to video and audio content provided via a video-on-demand service via the Internet; Broadcasting services, namely, transmission of advertising programs and media advertising communications via digital communications networks; Information transmission via electronic communications networks; Providing online chat rooms for social networking; Satellite, cable, network transmission of sounds, images, signals and data; Television broadcasting; Television program broadcasting; Television transmission services; Video broadcasting and transmission services via the Internet, featuring films and movies; Video broadcasting services via the Internet; Video streaming services via the Internet, featuring independent films and movies; Distribution of television programs for others; Editing of radio and television programs; Editing or recording of sounds and images; Entertainment media production services for motion pictures, television and Internet; Entertainment services in the nature of creation, development, and production of television programming; Post-production editing services in the field of music, videos and film; Production and distribution of television shows and movies; Production of visual effects for videos, DVDs, television and for internet web sites; Providing an Internet website portal in the field of music; Provision of non-downloadable films and movies via a video-on-demand service; Rental and computerized online rental services featuring interactive software and hardware home entertainment and consumer electronics in the nature of motion pictures, films, movies, prerecorded digital versatile discs (or DVDs), prerecorded videotape cassettes, audio, audio recordings in a variety of genres; Rental of pre-recorded videos that may be downloaded from an Internet web site; Video tape editing; Computer consultation in the field of computer security; Computer security consultancy; Computer services, namely, uploading music to the Internet for others; Digital transfer services for transferring home videos and film to DVD and the internet; Providing a web site featuring technology that enables internet users to share documents, images and videos; Providing a web site featuring temporary use of non-downloadable software allowing web site users to upload online videos for sharing with others for entertainment purposes; Providing a web site featuring temporary use of non-downloadable software allowing web site users to upload, post and display online videos for sharing with others for entertainment purposes; Providing a website allowing users to upload and download music; Providing a website featuring technology that enables users to share audio visual materials; Providing an interactive web site featuring technology that allows users to upload, download, share and sell custom and branded digital publications; Internet-based social networking services; Online social networking services; Providing information in the field of building security via the Internet; Security consultancy; Digital materials, namely, CDs, DVDs, mp3s, mp4s, downloadable audio files, downloadable video files, ring tones, software featuring television shows in the areas of documentaries, comedy, drama, education, religion, entertainment, sports, culture, music, business, reality and news; full length films in the areas of documentaries, comedy, drama, education, religion, entertainment, sports, culture, music, business, reality and news; short feature length films in the areas of documentaries, comedy, drama, education, religion, entertainment, sports, culture, music, business, reality and news; music videos; short audio visual clips in the field of documentaries, comedy, drama, education, religion, entertainment, sports, culture, music, business, reality and news; Digital media, namely, CDs, DVDs, mp3s, mp4s, downloadable audio files, downloadable video files, ring tones, games, software featuring television shows in the areas of documentaries, comedy, drama, education, religion, entertainment, sports, culture, music, business, reality and news; full length films in the areas of documentaries, comedy, drama, education, religion, entertainment, sports, culture, music, business, reality and news; short feature length films in the areas of documentaries, comedy, drama, education, religion, entertainment, sports, culture, music, business and news; music videos; short audio visual clips; Digital music downloadable from the Internet; Downloadable computer graphics; Downloadable electronic publications in the nature of electronic newsletters in the in the areas of documentaries, comedy, drama, education, religion, entertainment, sports, culture, music, business, reality and news; Downloadable films and movies featuring television shows in the areas of documentaries, comedy, drama, education, religion, entertainment, sports, culture, music, business, reality and news; full length films in the areas of documentaries, comedy, drama, education, religion, entertainment, sports, culture, music, business, reality and news; short feature length films in the areas of documentaries, comedy, drama, education, religion, entertainment, sports, culture, music, business, reality and news; music videos; short audio visual clips provided via a video-on-demand service in the areas of documentaries, comedy, drama, education, religion, entertainment, sports, culture, music, business, reality and news; Downloadable films and television programs featuring television shows in the areas of documentaries, comedy, drama, education, religion, entertainment, sports, culture, music, business, reality and news; full length films in the areas of documentaries, comedy, drama, education, religion, entertainment, sports, culture, music, business, reality and news; short feature length films in the areas of documentaries, comedy, drama, education, religion, entertainment, sports, culture, music, business, reality and news; music videos; short audio visual clips provided via a video-on-demand service in the areas of documentaries, comedy, drama, education, religion, entertainment, sports, culture, music, business, reality and news; Downloadable motion pictures and television shows about documentaries, comedy, drama, education, religion, entertainment, sports, culture, music, business, reality and news; Downloadable MP3 files and MP3 recordings featuring ring tones, music, podcasts in the areas of documentaries, comedy, drama, education, religion, entertainment, sports, culture, music, business, reality and news; Downloadable MP3 files, MP3 recordings, on-line discussion boards, webcasts, webinars and podcasts featuring music, audio books in the field of documentaries, comedy, drama, education, religion, entertainment, sports, culture, music, business, reality and news broadcasts; Downloadable multimedia file containing artwork, text, audio, video, and Internet Web links relating to in the areas of documentaries, comedy, drama, education, religion, entertainment, sports, culture, music, business, reality and news; Downloadable musical sound recordings; Downloadable podcasts in the field of in the areas of documentaries, comedy, drama, education, religion, entertainment, sports, culture, music, business, reality and news; Downloadable video recordings featuring television shows in the areas of documentaries, comedy, drama, education, religion, entertainment, sports, culture, music, business, reality and news; full length films in the areas of documentaries, comedy, drama, education, religion, entertainment, sports, culture, music, business, reality and news; short feature length films in the areas of documentaries, comedy, drama, education, religion, entertainment, sports, culture, music, business, reality and news; music videos; short audio visual clips in the areas of documentaries, comedy, drama, education, religion, entertainment, sports, culture, music, business, reality and news; Downloadable webcasts in the field of television shows in the areas of documentaries, comedy, drama, education, religion, entertainment, sports, culture, music, business, reality and news; full length films in the areas of documentaries, comedy, drama, education, religion, entertainment, sports, culture, music, business, reality and news; short feature length films in the areas of documentaries, comedy, drama, education, religion, entertainment, sports, culture, music, business and news; music videos; short audio visual clips in the areas of documentaries, comedy, drama, education, religion, entertainment, sports, culture, music, business, reality and news; Downloadable audio files, video files, ring tones, software via the internet and wireless devices in the areas of documentaries, comedy, drama, education, religion, entertainment, sports, culture, music, business, reality and news; Applications; Software Applications; games; performances; events; publishing; broadcasting; streaming; downloading; licensing; posting on a message board; posting on forums; a social network; emailing; texting; copyrighted materials, poems, literature, photos, artwork, intellectual property, music, art, photos, pictures, books, movies, tickets for events, merchandise, consumer and commercial goods, licenses, performances, events, publishing, broadcasting, streaming, downloading, and licensing; I-Pads, I-Phones, Androids.

Network System

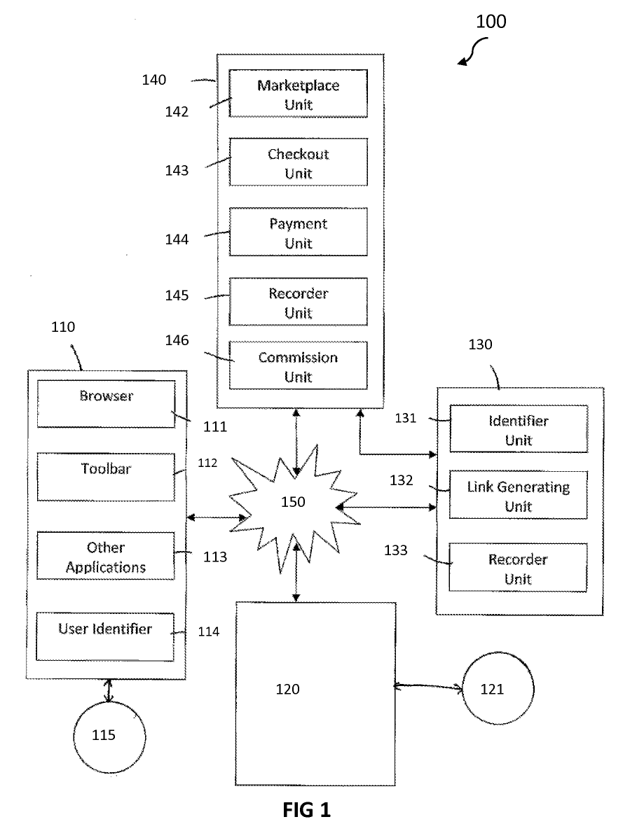

FIG. 1 depicts a block diagram of a network system 100 for referrals in an online marketplace in accordance with an inventive embodiment. System 100 may include a first consumer device 110, a second consumer device 120, a referral server 130, and a marketplace server 140 in communication over a network 150. The referral server 130 and the marketplace server 140 may be connected outside of the network 150 and may be embodied wholly or partially together in a machine readable medium or computer system.

First consumer device 110, second consumer device 120, referral server 130, and marketplace server 140 may each include one or more processors, memories, and other appropriate components for executing instructions such as program code and/or data stored on one or more computer readable mediums to implement the various applications, data, and steps described herein. For example, such instructions may be stored in one or more machine and/or computer readable mediums such as memories or data storage devices internal and/or external to various components of system 100, and/or accessible over network 150.

Network 150 may be implemented as a single network or a combination of multiple networks. For example, in various embodiments, network 150 may include the Internet or one or more intranets, landline networks, wireless networks, and/or other appropriate types of networks.

In an embodiment, operating a referral server in communication with a marketplace server over a network may include the referral server being located at a physically different location than the marketplace server, onsite with the marketplace server, or within the same computer as the marketplace server. The marketplace server comprises an electronic commerce website accessible by a web browser configured for online electronic commerce e.g., buying and selling, of item including goods and/or services.

Consumer devices 110 and 120 may be implemented using any appropriate combination of hardware and/or software configured for wired and/or wireless communication over network 150. For example, in one embodiment, consumer devices 110 and 120 may be implemented as personal computers of a first user 115 and a second user 121, respectively, in communication with the Internet. In other embodiments, consumer devices 110 and 120 may be implemented as mobile phones, smartphones, personal digital assistants (PDA), tablet computers, desktop computers, laptop and notebook computers, and the like. Consumer devices 110 and 120 may be similar to each other, and thus, the description of the first consumer device 110 may apply equally to the second consumer device 120. It is contemplated consumer device 110 may be a smartphone and consumer device 120 may be another type of personal computer such as a laptop while still considering consumer devices 110 and 120 to be similar.

In one or more embodiments, first consumer device 110 may include one or more browser applications 111 which may be used, for example, to provide a convenient interface to permit user 115 to browse information available over network 150. In one or more embodiments, browser application 111 may be implemented as a web browser configured to view information available over the Internet. First consumer device 110 may also include one or more toolbar applications 112 which may be used, for example, to provide consumer-side processing for performing desired tasks in response to operations selected by user 115 of the first consumer device 110. In one embodiment, toolbar application 112 may display a user interface in connection with browser application 111. First consumer device 110 may further include other applications 113 as may be desired in particular embodiments to provide desired features to first consumer device 110. For example, in various embodiments, such other applications 113 may include security applications for implementing consumer-side security features, programmatic consumer applications for interfacing with appropriate application programming interfaces (APIs) over network 150, or other types of applications. Applications 113 may also include email applications that allow user 115 to send and receive emails through network 150. First consumer device 110 includes one or more user identifiers 114 which may be implemented, for example, as operating system registry entries, cookies associated with browser application 111, identifiers associated with hardware of first consumer device 110, or other appropriate identifiers. In one or more embodiments, user identifier 114 may be used by the referral server 130 to associate the first user 115 with the referral server 130 or the marketplace server 140, or both servers 130 and 140. In one or more embodiments, user identifier 114 may be used by the marketplace server 140 to associate the first user 115 with the referral server 130 or marketplace server 140, or both 130 and 140. In one or more embodiments, user identifier 114 may be used by the marketplace server 140 to associate the second user 121 with marketplace server 140.

In one or more embodiments, marketplace server 140 may be maintained by an online merchant or online marketplace offering various items on an online website accessible for viewing and transaction over network 150.

In one or more embodiments, marketplace server 140 may include a marketplace unit 142. The marketplace unit 142 may allow users 115 and 121 to create a profile or user account for use on an online marketplace website associated with the system 100. Marketplace unit 142 may maintain user accounts or profiles, each of which may include information associated with individual users, such as users 115 and 121. In one or more embodiments, information may include name and email which may be used to facilitate online transactions made by or facilitated by users 115 and/or 121. The marketplace unit 142 may evaluate, and either accepted or rejected, items submitted by users 115 and 121 based on qualities such as originality, completeness, and explicit content. If users 115 and/or 121 submit an appropriate item to the marketplace unit 142, the marketplace unit 142 may make the item available, i.e. list the item, on the online marketplace website of the system 100. If the content of the item is inappropriate, the marketplace unit 142 may reject the item and notify the user whom submitted the item of the rejection by any suitable communication method, such as email or text or voice message.

Additionally, the marketplace unit 142 may make items available for viewing and transaction on the website, i.e. to list the items, for consumers such as first user 115 and/or second user 121 through network 150. Marketplace unit 142 may be configured to provide information regarding items over network 150 to browser 111 of first consumer device 110 and/or a similar browser of second consumer device 120. In one or more embodiments, users 115 and 121 may interact with marketplace unit 142 through browsers over network 150 in order to search and view various items listed by the marketplace unit 142 on the online marketplace website. In one or more embodiments, the marketplace unit 142 may evaluate items submitted by users for listing on the online marketplace website. The online marketplace website may be hosted on the marketplace server 140 or on another server.

In one or more embodiments, the marketplace unit 142 may determine if a click through associated with a user has occurred. The marketplace unit 142 also may determine if a transaction has been made regarding the click-through that occurred. If a user 115 and/or 121 is eligible for a commission as a result of a consumer clicking through a link provided by the referral server 130 or marketplace unit 142 in system 100, the marketplace unit 142 may award the commission to the user (which is also a marketer if user is eligible for a commission).

Marketplace server 140 may also include a checkout unit 143 which may be configured to facilitate transactions by users 115 and/or 121 of items made available by marketplace unit 142. In this regard, checkout unit 143 may be configured to accept payment information from users 115 and/or 121 and/or from payment unit 144.

In one or more embodiments, marketplace server 140 may include a payment unit 144. Payment unit 144 may be located within the marketplace server 140 or may be located in separate server of a third-party payment service provider, such as an online payment service provider. The payment unit 144 may provide payment on behalf of users 115 and/or 121 to an operator of marketplace server 140. In this regard, payment unit 144 includes one or more payment applications which may be configured to interact with consumer device 110, consumer device 120, and/or marketplace server 140 over network 150 to facilitate the transaction of items by users 115 or 121 of consumer devices 110 or 120, respectively, from marketplace server 140.

In one or more embodiments, marketplace server 140 may include a recorder unit 145 to record available items. The recorder unit 145 of the marketplace server 140 may record information of the users 115 and 121 after listing an item(s), or the recorder unit 145 may record information of users 115 and 121 without submitting an item for listing. The information may be a name and email. In one or more embodiments, information from the user accounts or profiles of the marketplace unit 142 may be used by recorder unit 145 to record click-throughs from a link to an item listing where the item has been listed by user 115 or 121. In one or more embodiments, marketplace unit 142 may be configured to interact with recorder unit 145 of marketplace server 140 or recorder unit 133 of referral server 130 on behalf of users 115 and/or 121 during a transaction with checkout unit 143 to track and manage transactions made from users who clicked through a link provided by users 115 and/or 121 (who obtained the link from either the link generating unit 132 of the referral server 130 or the marketplace unit 142 of the marketplace server 140. In one or more embodiments, the recorder unit 145 of the marketplace server 140 may record the total number of click-throughs of a link identified with a particular user, such as users 115 and/or 121. In one or more embodiments, the recorder unit 145 of the marketplace server 140 may record the total number of click-throughs of a link identified with a particular item of a consumer transaction that is identified with a particular user, such as users 115 and/or 121. When recording click-throughs based on links communicated to other users by a user such as user 115 with the recorder unit 145, the user 115 is considered a marketer in system 100. The recording of at least one click-through associated with a user may be considered to be click-through data.

In one or more embodiments, marketplace server 140 may further include a commission unit 146 configured to calculate a commission of a user 115 and/or 121 that has taken the role of a marketer in system 100. Commission unit 146 may be configured to receive click-through data from marketplace unit 142, from recorder unit 145 of marketplace server 140, from various units in the referral server 130, or from users 115 and 121 in order to determine the number of click-throughs identified with a marketer, the number of click-throughs that resulted in a consumer transaction, the total value of consumer transactions identified with a particular user, and to calculate a commission for the marketer, such as user 115 or 121. In one or more embodiments, the commission may include a variable component based on information stored in marketplace server 140 or in referral server 130.

The system 100 may include a referral server 130. In one or more embodiments, the referral server 130 may have an identifier unit 131. The identifier unit 131 may identify users that have items listed on the online marketplace website. In one or more embodiments, the referral server 130 may have a recorder unit 133. The recorder unit 133 of the referral server 130 may record information of a user such as user 115 or 121. Referral server 130 may include a link generating unit 132 to generate unique links to items listed on the online marketplace website by users 115 and/or 121. The links associate a user of the system 100 with an item listed on the online marketplace website so that when another user of the system click-through the link to the website, the referral server 130 and/or marketplace server 140 keep track of the number of click-throughs for a link associated with a user. The link generating unit 132 may send the link to the marketplace server 140 and/or to a user such as user 115 or 121. Thus, marketplace server 140 may provide the link to the user or the referral server 130 may provide the link to the user. Once a user 115 or 121 communicates a link that is generated by the link generating unit 132, the user is termed a marketer. In one or more embodiments, the recorder unit 133 of the referral server 130 may record the total number of click-throughs of a link identified with a particular user, such as users 115 and/or 121. In one or more embodiments, the recorder unit 133 of the referral server 140 may record the total number of click-throughs of a link identified with a particular item of a consumer transaction that is identified with a particular user, such as users 115 and/or 121.

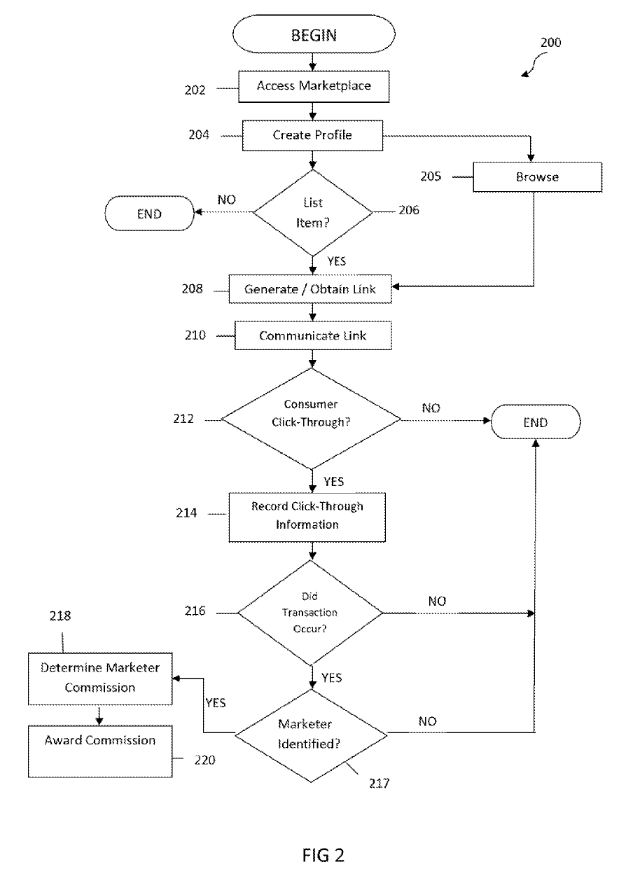

FIG. 2 depicts a flowchart 200 showing one embodiment of methods that may be performed by system 100. The method commences at block 202. At block 202, a user may access the online marketplace of the system 100, in one or more embodiments having the form of a website. The user may access the online marketplace by typing in a URL in a browser, taking a link from an email or text or another website, etc. Flow then proceeds to block 204.

At block 204, a user may create a profile, or account, in the online marketplace of the system 100. In one or more embodiments, the user may enter a name and an email address to complete the profile, but it is contemplated other information may be requested by the system 100 in order for the user to create a profile. The user may choose to upload information such as images, files, and descriptions of items to be listed on the website of the system 100 from the user's profile. If the user chooses to list items, flow then proceeds to decision block 206. If the user chooses not to list items, then flow proceeds to block 205.

At block 205, the user browses the online marketplace. In one or more embodiments, the user browses items in the online marketplace website. Flow then proceeds to block 208.

At decision block 206, after the user has uploaded information for items to be listed, the system 100 may decide whether to list the user's item. If the item is rejected, flow ends. If the item is accepted, flow then proceeds to block 208.

At block 208, the system 100 may generate, or the user may obtain, a link to the item on the online marketplace website. The system 100 may record information regarding the user and the item so that when another use clicks through the link, the system 100 uniquely associates the user with the item. The link may contain a unique identifier to associate the user with the item, such as a data string. Flow then proceeds to block 210.

At block 210, the user may communicate the link to other current or potential users of the system 100. The user may communicate the link by posting or sharing the link in a location where the other users may access the link and affirmatively observe and click on the link in order to click through to the online marketplace website showing the item listing. Locations for posting the link may include a social networking website, a forum, a text message, an email, etc. Flow then proceeds to decision block 212.

At decision block 212, the system 100 may determine whether a consumer (may or may not be a current user of the system) clicked-through the link to the item. If no, then flow ends. If yes, then flow proceeds to block 214.

At block 214, the system 100 may record click-through information, such as the identity of the item and the name or email or other identity of the marketer associated with the item. The system 100 may record data strings of the click-through information relating to the marketer and the item. The data strings may be combined or separate strings. Separate strings may be associated after the system 100 records click-through information in order to determine a commission for the marketer. Flow then proceeds to decision block 216. At decision block 216, the system 100 may determine whether a transaction has occurred as a result of the consumer's visit to the online marketplace website. If no, flow ends. If yes, flow continues to decision block 217.

At decision block 217, the system may determine whether a marketer is identified with the transaction of the item. If no, flow end. If yes, flow continues to block 218.

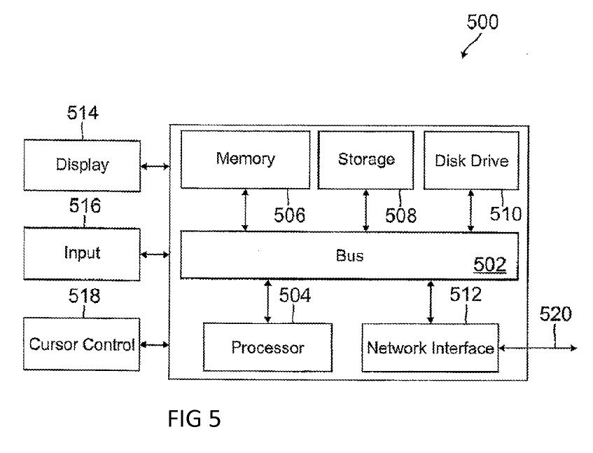

At block 218, the system 100 may determine a commission for the marketer associated with the transaction of the item. A base commission may be sent or made available to the marketer for a record of one click-through identified with the marketer to an item that had the transaction. The commission may be a percentage of a transaction price or value, or the commission may be a fee set by the system 100. The fee may be a flat fee or a hybrid flat fee with a sliding scale for the type of item listed in the online marketplace. The commission may be adjusted to a greater value for more than one click-through identified with the marketer, and the value of the commission may depend on the number of click-throughs, as discussed in more detail in FIG. 4. A cap commission of a largest value available (either percentage or absolute value) for marketers may be set so as to discourage fraud of marketers against the system 100. In one or more embodiments, the commission may be less than equal to about 100% of the value or price of the transaction. In one or more embodiments, the commission may be from about 5% to about 20% of the value or price of the transaction. In one or more embodiments, the commission may be less than about 1% of the value or price of the transaction. Flow then proceeds to block 220.

In one or more embodiments, the transaction price may be variable. For example, the transaction price may increase or decrease based on the timing of the transaction, the number of referrals by the marketer to the website, or the number of referrals of new profile creations of a marketer.

At block 220, the system 100 may award the commission to the marketer. To award the commission, the system 100 may make the commission available on the marketer's user profile in the system 100, may make the commission available by other means, or may affirmatively send the commission to the marketer.

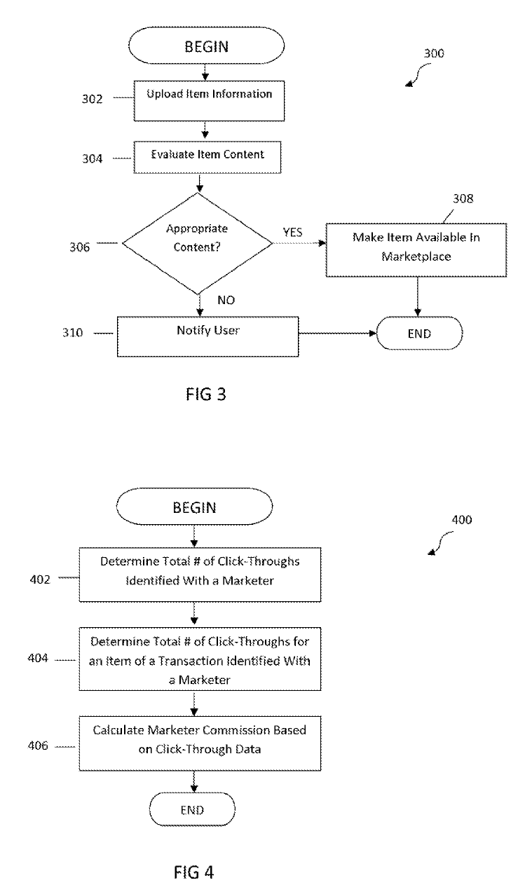

FIG. 3 depicts a flowchart 300 showing a method for listing an item according to one inventive embodiment. The method commences at block 302. At block 302, a user may upload information regarding an item to the system 100. Information regarding the item may include an image, a description, a file, etc. The user may upload information regarding the item from a consumer device, such as those described in FIG. 1 above. Flow then proceeds to block 304.

At block 304, the system 100 may evaluate the content of the item which was uploaded to the system 100 by the user. The system 100 may evaluate the item for originality, completeness, and explicit content. The system 100 may evaluate whether the item is original or not so as to discourage infringement of intellectual property or transactions with stolen items. The system 100 may evaluate whether the item is complete or incomplete, such as a corrupted file, so as to ensure complete items are made available for the listing. The system 100 may evaluate whether the item contains explicit content or not, such as adult materials, so as to prevent exposure of adult materials to persons under 18 using the system 100. Flow then proceeds to decision block 306.

At decision block 306, the system 100 may determine whether the evaluated content of the item is appropriate. If no, then flow proceeds to block 310. If yes, then flow proceeds to block 308.

At block 308, the system 100 may make the item available in the online marketplace by showing the item as listed on the online marketplace website. Flow of method 300 then ends.

At block 310, the system 100 may notify the user that the item the user attempted to list with the system 100 was rejected. A notification may or may not contain the reason for rejection. Flow of method 300 then ends.

FIG. 4 depicts a flowchart 400 showing a method for determining marketer commission according to one inventive embodiment. The method commences at block 402. At block 402, the system 100 may determine the total number of click-throughs identified with a marketer. Marketers in system 100 may obtain links for items which they listed or for other items which they did not list but wish to communicate the link to other users or potential users of the system 100; thus, block 402 sums the total number of click-throughs for items identified with the marketer whether or not the marketer listed the item. Flow then proceeds to block 404.

At block 404, the system 100 may determine the total number of clock-throughs for an item of a transaction that is identified with a marketer. In contrast to block 402, block 404 sums the total number of click-throughs only for items identified with the marketer. Blocks 402 and 404 may be determined in the same embodiment of the inventive methods, and it is contemplated blocks 402 and 404 may be determined in different embodiments of the inventive methods. Flow then proceeds to block 406.

At block 406, the system 100 may calculate the commission due to the marketer based on the click-through data. Flow then ends.

In an embodiment, the referral server is operated independent of the marketplace server functioning as a service provided to the operator of the marketplace server.

FIG. 5 depicts a schematic diagram of a computer system 500 in an inventive embodiment. In various implementations, the user device may comprise a personal computing device (e.g., a personal computer, laptop, cell phone, PDA, etc.) capable of communicating with the network. The merchant and/or payment provider may utilize a network computing device (e.g., a network server) capable of communicating with the network. It should be appreciated that each of the devices utilized by users, merchants, and payment providers may be implemented as computer system 500 in a manner as follows.

In an embodiment, it is to be understood that the presently claimed invention is not affiliate marketing, which is defined as a revenue-sharing plan where an online automated marketing program lets Webmasters place an advertiser's banner ads or buttons on their own Web site wherein webmasters receive a referral fee or commission from conversions when a customer has clicked the affiliate link and performs the desired action, such as make a purchase or opt-in for downloads or newsletters on the advertiser's site. Advertisers invest in affiliate programs for lead generation, and, of course, sales. In contrast to affiliate marketing, the instant disclosure is directed to generating a first specific link uniquely associating the first member user identifier with a particular item, and not a particular website. Accordingly, a specific link may be utilized on a plurality of websites offering a particular item for sale. If the website is arrived at via a click through of the specific link, a commission is due to the user uniquely associated with that link.

In accordance with various embodiments of the present disclosure, computer system 500, such as a personal computer and/or a network server, includes a bus 502 or other communication mechanism for communicating information, which interconnects subsystems and components, such as a processing component 504 (e.g., processor, micro-controller, digital signal processor (DSP), etc.), a system memory component 506 (e.g., RAM), a static storage component 508 (e.g., ROM), a disk drive component 510 (e.g., magnetic or optical), a network interface component 512 (e.g., modem or Ethernet card), a display component 514 (e.g., CRT or LCD), an input component 516 (e.g., keyboard, keypad, or virtual keyboard), and a cursor control component 518 (e.g., mouse, pointer, or trackball). In one implementation, disk drive component 510 may comprise a database having one or more disk drive components.

In accordance with embodiments of the present disclosure, computer system 500 performs specific operations by processor 504 executing one or more sequences of instructions contained in system memory component 506, such as described for methods 200, 300, and 400 described in FIGS. 2, 3 and 4. Such instructions may be read into system memory component 506 from another computer readable medium, such as static storage component 508 or disk drive component 510. In other embodiments, hard-wired circuitry may be used in place of or in combination with software instructions to implement the present disclosure.

Logic may be encoded in a computer readable medium, which may refer to any medium that participates in providing instructions to processor 504 for execution. Such a medium may take many forms, including but not limited to, non-volatile media, volatile media, and transmission media. In various implementations, non-volatile media includes optical or magnetic disks, such as disk drive component 510, volatile media includes dynamic memory, such as system memory component 506, and transmission media includes coaxial cables, copper wire, and fiber optics, including wires that comprise bus 502. In one example, transmission media may take the form of acoustic or light waves, such as those generated during radio wave and infrared data communications.

In various embodiments of the present disclosure, execution of instruction sequences to practice the present disclosure may be performed by computer system 500. In various other embodiments of the present disclosure, a plurality of computer systems 500 coupled by a communication link 520 to the network (e.g., such as a LAN, WLAN, PTSN, and/or various other wired or wireless networks, including telecommunications, mobile, and cellular phone networks) may perform instruction sequences to practice the present disclosure in coordination with one another.

Computer system 500 may transmit and receive messages, data, information and instructions, including one or more programs (i.e., application code) through communication link 520 and a communication interface 512. Received program code may be executed by processor 504 as received and/or stored in disk drive component 510 or some other non-volatile storage component for execution.

Links may be generated in two different scenarios in the inventive systems 100/500, methods 200/300/400, and machine readable mediums containing embodiments of the systems 100/500 and methods 200/300/400. In a first scenario, a user may create a profile and market items which the user did not submit for transactions, i.e. the item was submitted by another user. In a second scenario, a user may create a profile and submit items for transactions.

In the first scenario the user transforms into a marketer only and does not enter into transactions. The marketer may obtain, and the systems 100/500 may generate a marketer-only link to the website and to any items for which the user obtains a link. The marketer-only link may contain tracking code (can be encrypted) for the marketer and the website, and the systems 100 and 500 may identify the marketer by recognizing the marketer tracking code when someone clicks through the link to the website. Additionally, the systems 100 and 500 may track additional clicks made by the someone in the online marketplace website and may retain the identity of the marketer by maintaining identity of the marketer tracking code from the link initially clicked through by the someone.

In the second scenario, the user transforms into a merchant and a marketer. The user may obtain, and the systems 100/500 may generate a merchant-marketer link to the website and to items for which the user listed on the online marketplace. The merchant-marketer link contains tracking code (can be encrypted) for the marketer and the merchant's items, and the systems 100/500 may identify the merchant-marketer by recognizing the merchant-marketer tracking code when someone clicks through the merchant-marketer link to the item on the online marketplace website. Additionally, the systems 100 and 500 may track additional clicks made by the someone in the online marketplace website and may retain the identity of the merchant-marketer by maintaining the identity of the merchant-marketer tracking code from the link initially clicked through by the someone.

Not only do the users undergo transformation into marketers and merchant-marketers, so do the consumer devices of the users. In the first scenario above, the consumer device of the user transforms into a marketing device when communicating in or with systems 100/500. In the second scenario above, the consumer device of the user transforms into a merchant device and into a marketing device when communicating in or with systems 100/500.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

### EMBODIMENTS

Accordingly, the present invention provides the following embodiments of the invention:

A. A method for conducting electronic commerce comprising:

operating a referral server in communication with a marketplace server over a network, the marketplace server comprising an electronic commerce website accessible by a web browser configured for online buying and selling of items;

receiving and storing a first member profile from a first member associated with the electronic commerce website to produce a first member user identifier;

associating the first member user identifier with a first item offered for sale on the electronic commerce website;

generating a first specific link uniquely associating the first member user identifier with the first item;

communicating the first specific link to the first member;

receiving a request for the first item via a click-through of the first specific link that results in a financial transaction on the electronic commerce website associated with the first item;

determining an amount of a commission receivable by the first member associated with the financial transaction associated with the first item; and

generating and storing information related to the commission receivable by the first member.

B. The method of embodiment A, wherein the first item is a service.

C. The method of embodiment A or B, further comprising receiving a listing from the first member to offer the first item for sale on the electronic commerce website.

D. The method of embodiment A, B, or C, further comprising receiving a listing from a second member to offer the first item for sale on the electronic commerce website.

E. The method of embodiment A, B, C, or D, wherein the first specific link is recorded on the referral server.

F. The method of embodiment A, B, C, D, or E, wherein each click-through of the first specific link is recorded by the referral server.

G. The method of embodiment A, B, C, D, E, or F, wherein the amount of the commission owed to the first member is determined relative to the number of the click-throughs of the first specific link.

H. The method of embodiment A, B, C, D, E, F, or G, wherein the amount of the commission owed to the first member is determined relative to the number of the click-throughs of the first specific link which resulted in a financial transaction on the electronic commerce website.

I. The method of embodiment A, B, C, D, E, F, G, or H, wherein the amount of the commission owed to the first member is determined relative to the number of the click-throughs of the first specific link which resulted in a financial transaction associated with the first item on the electronic commerce website.

J. The method of embodiment A, B, C, D, E, F, G, H, or I, wherein the amount of the commission owed to the first member is determined relative to the amount of the financial transaction on the electronic commerce website associated with the first item.

K. The method of embodiment A, B, C, D, E, F, G, H, I, or J, wherein information related to the commission receivable by the first member is communicated to the first member.

L. The method of embodiment A, B, C, D, E, F, G, H, I, J, or K, wherein information related to the commission receivable by the first member is communicated to a financial institution associated with the first member.

M. The method of embodiment A, B, C, D, E, F, G, H, I, J, K, or L, wherein the first item is an inventory of a plurality of identical items.

N. A system for conducting electronic commerce using a marketplace server configured to provide an electronic commerce website accessible by a web browser configured for online buying and selling of items comprising:

a referral server in communication with the marketplace server over a network;

the referral server configured to:

receive and store information provided by the marketplace server associated with a first member profile received from a first member associated with the website;

produce and record a first member user identifier based the first member profile;

associate the first member user identifier with a first item offered for sale on the electronic commerce website;

generate and record a first specific link uniquely associating the first member user identifier with the first item;

communicate the first specific link to the first member;

receive information from the marketplace server associated with a click-through of the first specific link that results in a financial transaction on the electronic commerce website;

determine an amount of a commission receivable by the first member associated with the financial transaction on the electronic commerce website; and

generate and record information associated with the commission receivable by the first member.

O. The system of embodiment N, wherein the first item is a service.

P. The system of embodiment N or O, wherein the referral server is further configured to receive and record information from the market place server associated with a listing from the first member or from a second member to offer the first item for sale on the electronic commerce website.

Q. The system of embodiment N, O, or P, wherein the referral server is configured to receive and record information associated with each click-through of the first specific link.

R. The system of embodiment N, O, P, or Q, wherein the referral server is configured to determine the amount of the commission receivable by the first member associated with the financial transaction on the electronic commerce website relative to the number of the click-throughs of the first specific link, relative to the number of the click-throughs of the first specific link which resulted in a financial transaction associated with the first item on the electronic commerce website, relative to the amount of the financial transaction on the electronic commerce website associated with the first item, or a combination thereof.

S. The system of embodiment N, O, P, Q, or R, wherein the referral server is configured to communicate information related to the commission receivable by the first member to the first member, to a financial institution associated with the first member, or a combination thereof.

T. The system of embodiment N, O, P, Q, R, or S, wherein the first item is an inventory of a plurality of identical items.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter. The foregoing disclosure and description of the invention is illustrative and explanatory thereof and it can be readily appreciated by those skilled in the art that various changes in the size, shape and materials, as well as in the details of the illustrated construction or combinations of the elements described herein can be made without departing from the spirit of the invention.

While the invention has been illustrated and described in detail in the drawings and foregoing description, the same is to be considered as illustrative and not restrictive in character, it being understood that only some embodiments have been shown and described and that all changes and modifications that come within the spirit of the inventions are desired to be protected. It should be understood that while the use of words such as preferable, preferably, preferred, more preferred or exemplary utilized in the description above indicate that the feature so described may be more desirable or characteristic, nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

We claim:

1. A method for conducting electronic commerce comprising:
operating a referral server in communication with a marketplace server over a network, the marketplace server comprising an electronic commerce website accessible by a web browser configured for online buying and selling of items;
receiving and storing a first member profile from a first member associated with the electronic commerce website to produce a first member user identifier;
associating the first member user identifier with a first item offered for sale on the electronic commerce website;
generating a first specific link uniquely associating the first member user identifier with the first item;
communicating the first specific link to the first member;
receiving a request for the first item via a click-through of the first specific link that results in a financial transaction on the electronic commerce website associated with the first item;
determining an amount of a commission receivable by the first member associated with the financial transaction associated with the first item; and
generating and storing information related to the commission receivable by the first member.

2. The method of claim 1, wherein the first item is a service.

3. The method of claim 1, further comprising receiving a listing from the first member to offer the first item for sale on the electronic commerce website.

4. The method of claim 1, further comprising receiving a listing from a second member to offer the first item for sale on the electronic commerce website.

5. The method of claim 1, wherein the first specific link is recorded on the referral server.

6. The method of claim 1, wherein each click-through of the first specific link is recorded by the referral server.

7. The method of claim 1, wherein the amount of the commission owed to the first member is determined relative to the number of the click-throughs of the first specific link.

8. The method of claim 1, wherein the amount of the commission owed to the first member is determined relative to the number of the click-throughs of the first specific link which resulted in a financial transaction on the electronic commerce website.

9. The method of claim 1, wherein the amount of the commission owed to the first member is determined relative to the number of the click-throughs of the first specific link which resulted in a financial transaction associated with the first item on the electronic commerce website.

10. The method of claim 1, wherein the amount of the commission owed to the first member is determined relative to the amount of the financial transaction on the electronic commerce website associated with the first item.

11. The method of claim 1, wherein information related to the commission receivable by the first member is communicated to the first member.

12. The method of claim 1, wherein information related to the commission receivable by the first member is communicated to a financial institution associated with the first member.

13. The method of claim 1, wherein the first item is an inventory of a plurality of identical items.

14. A system for conducting electronic commerce using a marketplace server configured to provide an electronic commerce website accessible by a web browser configured for online buying and selling of items comprising:
a referral server in communication with the marketplace server over a network;
the referral server configured to:
receive and store information provided by the marketplace server associated with a first member profile received from a first member associated with the website;
produce and record a first member user identifier based the first member profile;
associate the first member user identifier with a first item offered for sale on the electronic commerce website;
generate and record a first specific link uniquely associating the first member user identifier with the first item;
communicate the first specific link to the first member;
receive information from the marketplace server associated with a click-through of the first specific link that results in a financial transaction on the electronic commerce website;
determine an amount of a commission receivable by the first member associated with the financial transaction on the electronic commerce website; and
generate and record information associated with the commission receivable by the first member.

15. The system of claim 14, wherein the first item is a service.

16. The system of claim 14, wherein the referral server is further configured to receive and record information from the market place server associated with a listing from the first member or from a second member to offer the first item for sale on the electronic commerce website.

17. The system of claim 14, wherein the referral server is configured to receive and record information associated with each click-through of the first specific link.

18. The system of claim 14, wherein the referral server is configured to determine the amount of the commission receivable by the first member associated with the financial transaction on the electronic commerce website relative to the number of the click-throughs of the first specific link, relative to the number of the click-throughs of the first specific link which resulted in a financial transaction associated with the first item on the electronic commerce website, relative to the amount of the financial transaction on the electronic commerce website associated with the first item, or a combination thereof.

19. The system of claim 14, wherein the referral server is configured to communicate information related to the commission receivable by the first member to the first member, to a financial institution associated with the first member, or a combination thereof.

20. The system of claim 14, wherein the first item is an inventory of a plurality of identical items.
